(19) United States
(12) Patent Application Publication
(10) Pub. No.: US 2012/0105574 A1
(43) Pub. Date: May 3, 2012

(54) PANORAMIC STEREOSCOPIC CAMERA

(76) Inventors: Henry Harlyn Baker, Los Altos, CA (US); Papadas Constantin, Athens (GR)

(21) Appl. No.: 12/914,771

(22) Filed: Oct. 28, 2010

(51) Int. Cl. H04N 5/225

(52) U.S. Cl. 348/36; 348/E13.074

(57) ABSTRACT

A panoramic stereographic camera includes a first cylindrical array of imagers with adjoining fields of view that cover a panoramic portion of a scene, each imager in the first cylindrical array being oriented at a first skew angle. A second cylindrical array of imagers with adjoining fields of view covers the same panoramic portion of the scene. Each imager in the second cylindrical array is oriented at a second skew angle. The images formed by the first cylindrical array of imagers and images created by the second cylindrical array of imagers are combined to produce a panoramic stereographic image.

### BACKGROUND

Panoramic imaging has a wide range of applications, including surveillance, scene capture, entertainment, remote navigation, and others. However, these panoramic cameras do not provide stereoscopic viewpoints. This limits their usefulness and does not provide intuitive depth perception of objects and terrain within the field of view.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1A is a diagram of an illustrative cylindrical array of imagers that form a 360 degree image, according to one example of principles described herein.

FIG. 1B is a diagram of two illustrative cylindrical arrays of imagers that form a 360 degree stereoscopic image, according to one example of principles described herein.

FIG. 1C is a diagram of illustrative binocular pairings between imagers in a first panoramic array and a second panoramic array, according to one example of principles described herein.

FIG. 1D is a perspective view of an illustrative panoramic stereoscopic camera, according to one example of principles described herein.

FIGS. 1E and 1F are diagrams that describe various parameters and relationships in an illustrative panoramic stereoscopic camera, according to one example of principles described herein.

FIGS. 2A and 2B show an illustrative pair of panoramic images that provide stereoscopic perspective, according to one example of principles described herein.

FIGS. 2C and 2D are illustrative left and right binocular views that provide stereoscopic perspective, according to one example of principles described herein.

FIG. 2E is a composite image of the left and right binocular views shown in FIGS. 2C and 2D, according to one example of principles described herein.

FIG. 3 is a diagram of an illustrative panoramic stereoscopic camera mounted to an armored vehicle, according to one example of principles described herein.

FIG. 4 is a diagram of an illustrative panoramic stereoscopic camera mounted to an unmanned helicopter, according to one example of principles described herein.

FIG. 5A is a diagram of two binocular views taken by a panoramic stereoscopic camera, according to one example of principles described herein.

FIG. 5B is a diagram of two composite binocular views taken by a panoramic stereoscopic camera at multiple wavelengths, according to one example of principles described herein.

FIGS. 6A and 6B are diagrams of an illustrative method and system, respectively, for creating and using panoramic stereoscopic images, according to one example of principles described herein.

Throughout the drawings, identical reference numbers designate similar, but not necessarily identical, elements.

### DETAILED DESCRIPTION

Panoramic images are wide angle views or representations of a physical space. Panoramic images are typically considered images that have a field of view that is greater than the human eye, which is about 160 degrees by 75 degrees.

Stereoscopic imaging refers to techniques that capture images in a way that records three dimensional visual information and/or creates an impression of depth in an image. Typically humans view their surroundings by combining two images, one from each eye. Human eyes are horizontally separated, and consequently view objects from slightly different angles. The difference in angle is most pronounced when viewing objects in close proximity to the observer and less pronounced for objects or scenes that are farther away. The slightly different angles of the objects in the images enhance the observer's depth perception and facilitate the rapid understanding of the scene.

As imaging and computing technologies advance, there are many situations where using a camera to capture an image has advantage over using a human observer. For long term or broad area surveillance, a number of strategically placed cameras can provide a security officer with real time and recorded images from a wide range of locations and angles. Drivers and commanders of armored vehicles in combat zones often rely on electronically generated images to navigate through terrain and identify threats while they remain in the relative safety of the vehicle interior. Remotely piloted aircraft also generate imagery to assist the operators in directing the aircraft operations.

However, these optical systems do not provide panoramic views with variable stereoscopic perspective. This can hamper the effectiveness of the operators relying on the imagery. For example, an armored vehicle driver who is supplied with a video output by an external camera exercises additional effort to understand the imagery because of lack of depth perception. This can force the driver to move more slowly and take other precautions. Similarly, the commander of the vehicle may have a larger panoramic view of the scene but may be also be hampered by the lack of stereoscopic perspective. The commander may be less likely to detect camouflaged threats or be slower to pinpoint dynamic targets. If the commander does have access to stereoscopic imagery, it is likely to have a very narrow field of view.

When stereoscopic perspectives are provided, they have been strictly limited in their positioning to adjacent placements, with parallax, radius, and field of view tightly coupled. This limits the distance over which 3D can be observed, and can lead to unnecessarily large camera apparatuses.

This specification describes illustrative imaging systems that provide panoramic viewing with stereoscopic perspectives in a compact form. These images are provided in real time and through 360 degrees. The stereoscopic perspective is provided over the entire panoramic image. Further, the illustrative imaging systems do not include moving parts such as rotating cameras or scanning mirrors. This increases the robustness of the imaging systems while reducing their size and cost. Operators using the illustrative systems described below have additional advantages in detecting threats and acting within the context of the situation to mitigate the threats.

In the following description, for purposes of explanation, numerous specific details are set forth in order to provide a thorough understanding of the present systems and methods. The present apparatus, systems and methods may be practiced without these specific details. The various instances of the phrase “in one example” or similar phrases in various places in the specification are not necessarily all referring to the same example.

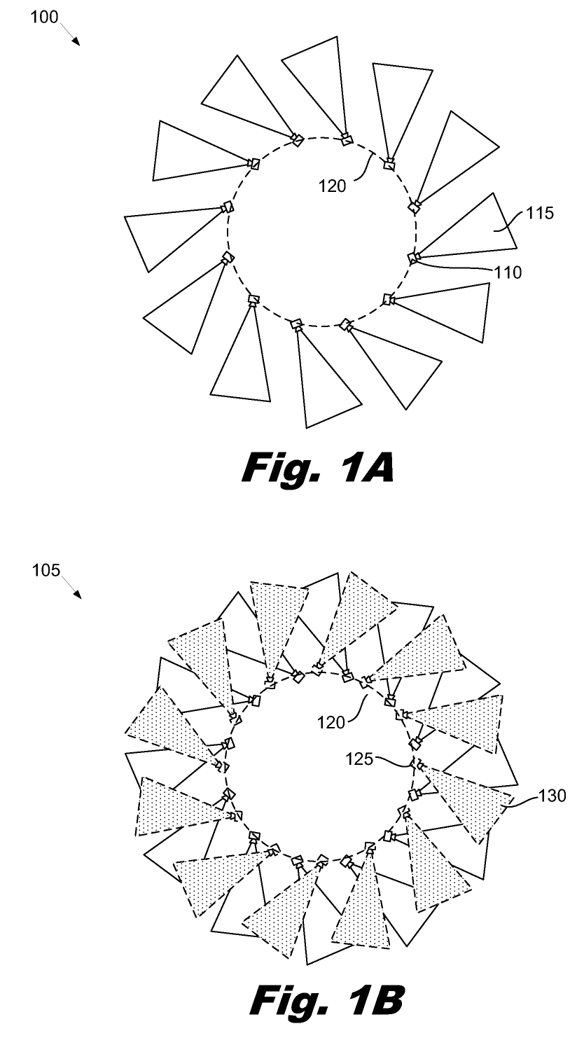

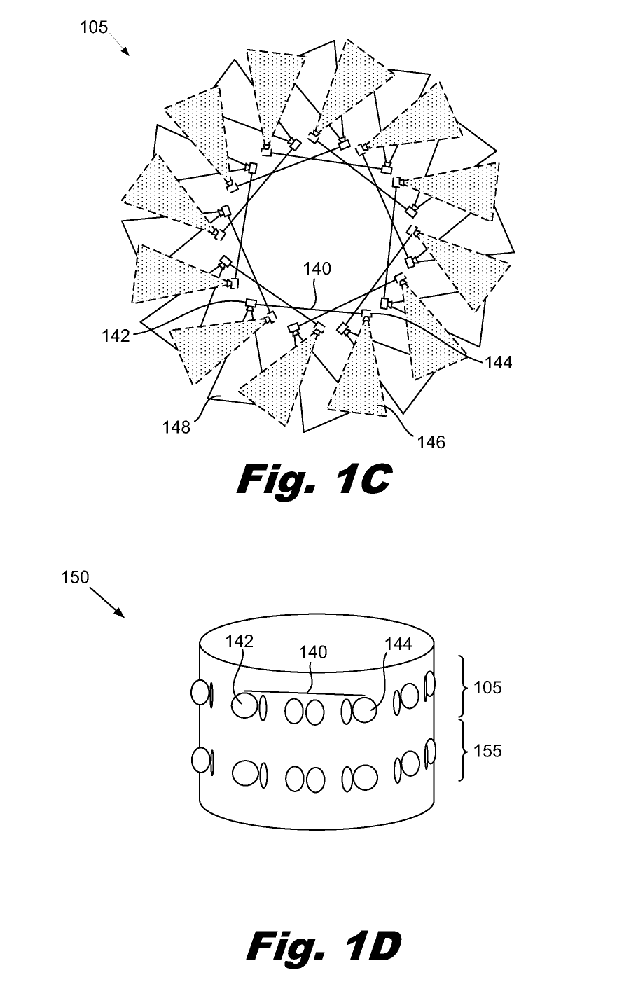

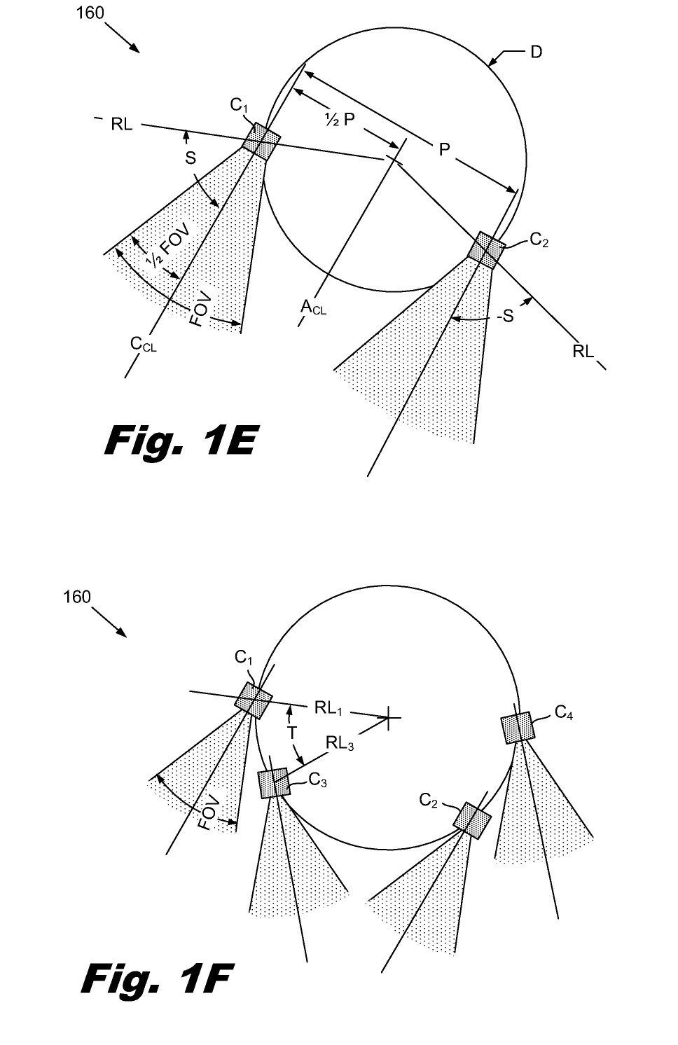

FIG. 1A is a diagram of an illustrative cylindrical array (100) of imagers that form a 360 degree image. The imagers are not placed normal to the circumference of the cylinder (120), but are oriented askew. In this example, data from 12 imagers (110) with approximately 30 degree fields of view (115) are combined to make the 360 degree panoramic image. Each successive imager points in a direction that is approximately 30 degrees different from its nearest neighbors in the array. At this point, the panoramic image formed by the cylindrical array is not stereoscopic.

As used in the specification and appended claims, the term “cylindrical array” refers to a planar arrangement of imagers in which the imagers are equally distant from a central point. The imagers may or may not be mounted to an actual cylinder. In some examples, the cylindrical array of imagers may be mounted in a circle on a flat plate or other object. The continuous image is created by aligning the imagers so that they have adjoining fields of view and then stitching or combining adjoining images. As used in the specification and appended claims the term “adjoining fields of view” refers to adjacent fields of view that abut but may or may not overlap. Adjoining fields of view do not have a substantial gap between them. As used in the specification and appended claims the terms “substantial gap” refers to any gap that would be readily observable to a user of a surveillance system. The change in pointing angle of successive imagers in the array is less than or equal to the field of view of the imagers in the array. This results in adjoining fields of view and continuous angular coverage of the panoramic image.

In FIG. 1B, a second cylindrical array of imagers (125) is added to the first array (100) to form a combined array (105). To distinguish the second array of imagers (125) from the first array of imagers (110), the second array of imagers (125) is illustrated with shaded fields of view (130) that are outlined by dashed lines. In this illustrative example, the imagers in the first cylindrical array point in a clockwise orientation at a first skew angle and the imagers in the second cylindrical array point in a counterclockwise orientation at a second skew angle. In some examples, the second skew angle has the same magnitude but opposite sign of the first skew angle. The second array of imagers (125) is coplanar with the first array of imagers (110) and interspersed between the first array of imagers (110). This second array of imagers (125) provides the additional information to generate the stereoscopic perspective over the entire 360 degrees.

FIG. 1C is a diagram of illustrative binocular pairings between imagers in the first panoramic array and the second panoramic array. These binocular pairings are illustrated as solid black lines (140) that connect two imagers (142, 144). Each pair (140) of imagers has one imager (142) from the first array and a one imager (144) from the second array. Each pair of imagers has approximately parallel fields of view (146, 148) that are offset by a parallax distance that is equal to the length of solid black line (140). In one example, the imager pairs are mutually coplanar and exhibit the same horizontal parallax. Thus, the imager illustrated in FIG. 1C can also be described as a plurality of coplanar binocular pairs of imagers arranged in a 360 degree cylindrical array.

If the intent of the imager is to simulate human vision, the parallax distance can be selected to match the interpupillary distance of an average adult (45 to 75 millimeters, with an average distance of approximately 64 millimeters). In other applications, it may be advantageous to increase or decrease this distance. For example, in applications where the size or mass of the camera is a significant design factor, the parallax distance may be reduced to allow the overall size of the camera to be reduced. In applications where large parallax distances are desired for a more three dimensional perspective, the distance between associated imagers could be increased.

The imager pairs are interspersed such that each imager pair is separated by at least one imager. This makes the array more compact while keeping the parallax distance relatively large with respect to the diameter of the circle. This allows the size of the cylinder to be reduced when compared to configurations that have separate binocular pairs that have no imagers between the pairs. In FIG. 1C, there are four imagers between each pair. In this configuration, the parallax offset is greater than the radius of the cylinder.

The examples shown above are only illustrative of configurations that could be used. For example, more or fewer imagers could be used in the camera. For example, 16 imagers could be used, each covering approximately 45 degrees of a 360 degree field of view. In these examples, there is not substantial overlap or gaps in the adjoining fields of view. Additionally, the composite field of view of the camera may be more or less than a planar 360 degrees. In some applications it may be desirable for the camera to form a 180 degree or 270 degree image rather than 360 degrees. In other examples, additional imagers may be added to the camera on a sphere rather than a circle to expand the planar 360 degree field of view to a hemispherical field of view.

FIG. 1D is a perspective view of an illustrative cylindrical camera (150) that provides stereoscopic panoramic images using two different wavebands. For example, the upper combined array (105) may be a visible-spectrum camera that includes 24 imagers as described in FIG. 1C and the lower array (155) may use infrared imagers. The lower array (155) may have a range of imager configurations that include more or fewer imagers than the upper array (105). The number and geometry of the imagers can be selected based on a number of factors, including: cost, size, power consumption, field of view, focal plane sensitivity and other factors. In the example shown in FIG. 1D, the lower array (155) includes 24 imagers and has a configuration that is identical to the upper array (105).

The imagers in the cylindrical camera (150) are illustrated in perspective as circles or ellipses. The imagers that are pointed out of the page are illustrated as being more circular, while those that are pointing at oblique angles are shown being more elliptical. The centers of projection of these imagers lie approximately on the circle. The numbered pair (140) of imagers (142, 144) point out of the page. As discussed above, this imager pair (140) provides stereoscopic imagery through a portion of the panoramic image produced by the cylindrical camera (150).

The panoramic and stereoscopic data from the infrared camera array (155) may be used alone or combined with the visible-spectrum imagery. The infrared imager may have advantages in low light environments, for acquisition and tracking of heat generating targets, locating targets in dust, haze or smoke; search and rescue operations, driving in low visibility conditions, and other situations. The combination of infrared and visible data can be particularly effective in camouflage breaking because heat signatures can be difficult to hide.

FIGS. 1E and 1F are diagrams that describe various parameters and relationships in an illustrative panoramic stereoscopic camera (160). FIG. 1E shows an imager pair (C₁, C₂), with each imager having an associated field of view (FOV). The array center line A_{CL} is a radial line that passes from the center of the array outward to a point midway between the two imagers in the binocular pair. Consequently, the array center line A_{CL} is at a different angle for each binocular pair. The optical center line (C_{CL}) of each imager in a binocular pair is parallel to and offset from array center line (A_{CL}). In this example, the optical center line (C_{CL}) of each imager (C₁, C₂) is offset from the array center line A_{CL} by the distance ½ P. Thus, the separation between the two imagers (C₁, C₂) is the parallax distance P. In this example, the parallax distance P is a horizontal offset that is uniform across all imager pairs in the camera.

In this illustrative example, the imagers (C₁, C₂) are not pointed along the radial line RL that extends from the center of the array radially outward and through a reference point in the imagers. In contrast, each imager in the first cylindrical array is oriented at a first skew angle (S) with respect to a radial line (RL) passing from the center of cylindrical array through a reference point in each imager in the first cylindrical array. Each imager in the second cylindrical array is oriented at a skew angle that is of approximately the same magnitude but opposite in directionality (-S). The skew angle S is measured between the radial line RL and the imager center line C_{CL}. This skew angle allows the imagers belonging to different pairs to be intermingled with each other. The intermingling of imager pairs as shown in FIGS. 1B-1D provides wider parallax, smaller sensor size, and greater pixel density per unit volume of the imager.

In general, the number of imagers in a given array relates to the surveillance angle and the field of view of the imager. In the FIGS. 1B-1D, the surveillance angle is 360 degrees. For complete binocular coverage of the surveillance angle without substantial gaps or overlap between fields of view of the imagers it can be shown that:

NC=(2*A_{S})/θ Eq. 1

Where:
NC=number of imagers
Aₛ=surveillance angle
θ=the field of view (FOV) of the imagers

For this and following examples, it is assumed that each imager in the array has an identical field of view. Thus, a system that has a surveillance angle (Aₛ) of 360 degrees and imagers with a 30 degree field of view θ (FOV) would have 24 imagers, with 12 imagers arranged in a first circular array and with a first skew angle and 12 other imagers arranged in a second circular array and having skew angle of opposite sign.

The skew angle can be calculated using the following formula:

S=atan(B/2R) Eq. 2

Where:
B=the separation between imagers
R=the radius of the circle.

For radially symmetric imagers, a maximum upper bound for the parallax distance is the diameter of the array D. Equation 3 approximates the maximum parallax (Pₘₐₓ) for a panoramic stereoscopic imager.

Pₘₐₓ=2R*tan(θ/2) Eq. 3

Where:
Pₘₐₓ=the maximum parallax of the imager
R=cylinder radius
θ=desired field of view of each imager
   Equation 3 arises from the consideration of occlusion each imager presents to its neighbors and assumes that the body of each imager is infinitesimal. The true limit on parallax (paired imager displacement) would be less, since imagers have a non-zero footprint.

FIG. 1F represents the distribution of imagers around the perimeter of the panoramic stereoscopic array. In general, the angular separation (T) between imagers in a cylindrical array is approximately equal to the field of view of the imagers. This assumes that the imagers have the same field of view and that there is not significant overlap between the fields of view of the imagers.

Overlap between imager fields of view can be beneficial in some regards. For example, overlap between fields of view can provide redundant information that facilitates stitching and color balancing of adjacent images. However, overlap in a three dimensional image setting can be less desirable because the two imagers that have overlapping fields of view have different viewing angles and perspectives. Consequently, merging data from overlapping images could be visually confusing and obscure depth perception. According to one illustrative example, there is no substantial overlap between fields of view of imagers in the same cylindrical array. The fields of view in each cylindrical array directly abut each other to provide panoramic images without overlap or gaps between the individual images. As discussed above, the superposition of a panoramic image produced by the first cylindrical array and a panoramic image produced by the second cylindrical array creates the stereoscopic panoramic image.

The equations above represent only one illustrative method for calculating the number and orientation of imagers within a panoramic stereoscopic camera. A variety of other methods, geometries, and configurations could be used.

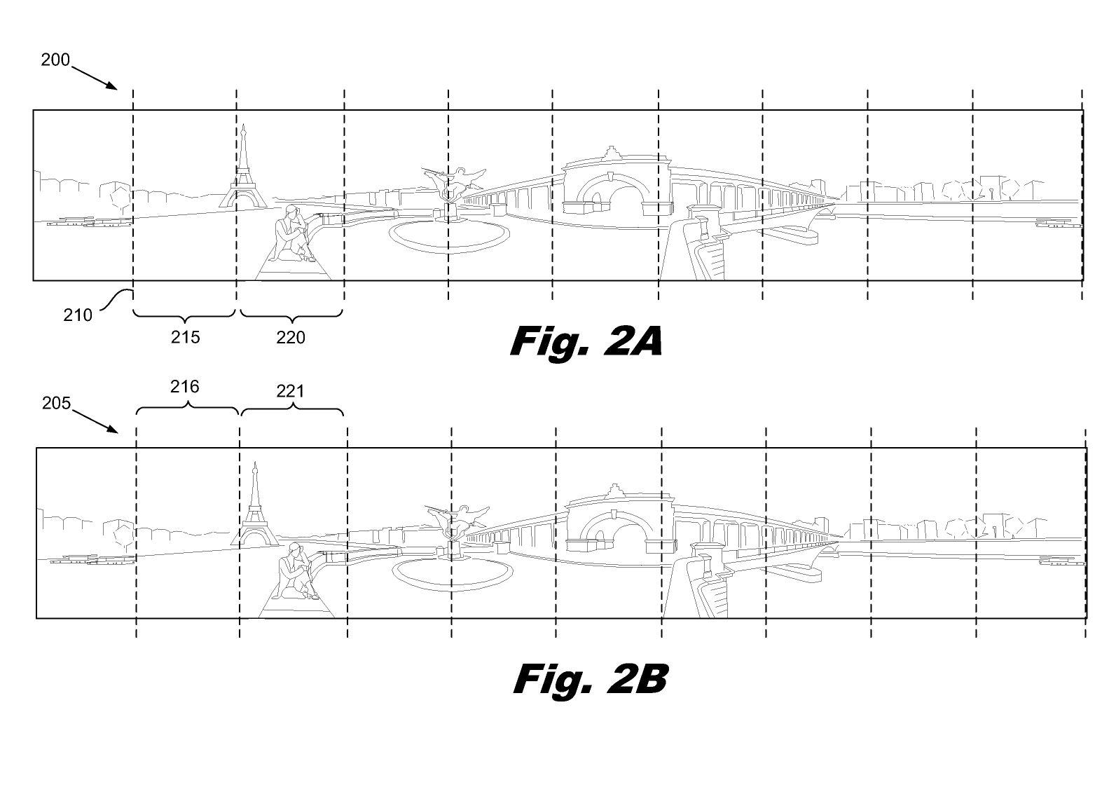

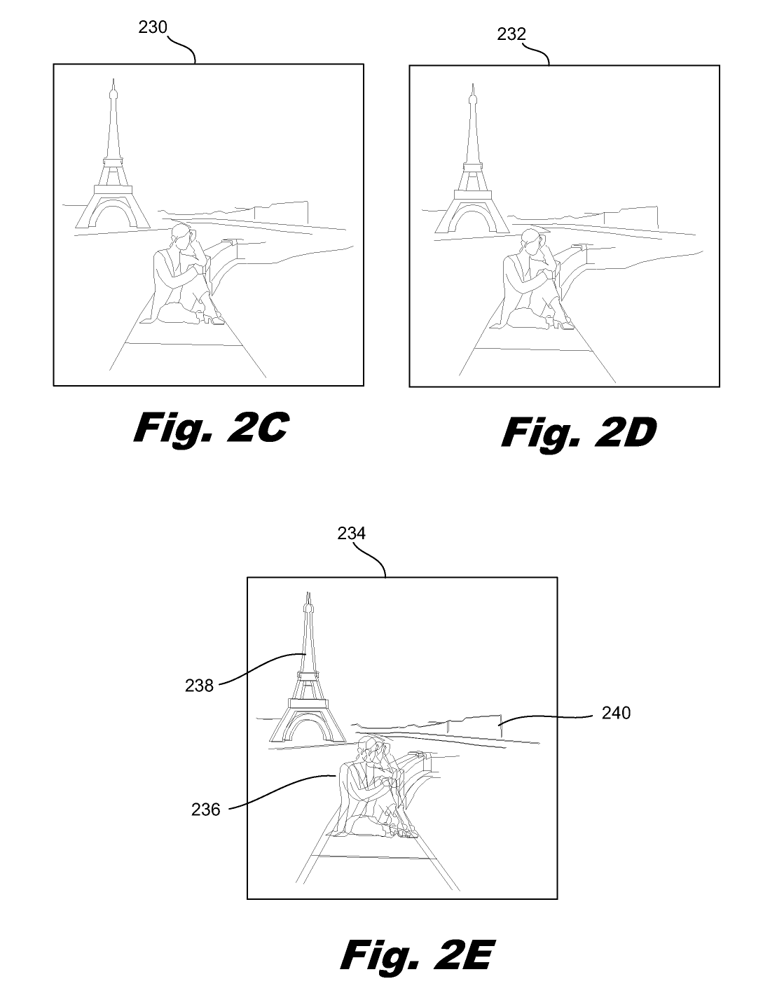

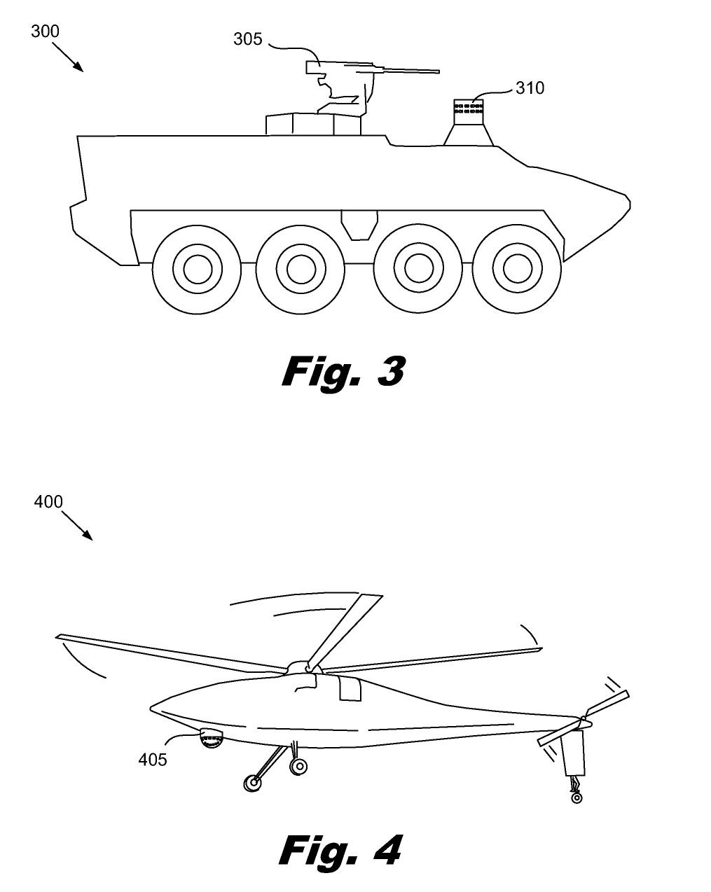

FIGS. 2A and 2B are an illustrative pair of panoramic images (200, 205) that are combined to provide stereoscopic perspective. In this example, the panoramic images are taken in an urban scene and may be used to create images or movies for display or entertainment purposes. Additionally, the images provided by the panoramic stereoscopic camera (150, FIG. 1D) may be used for surveillance, security, or other purposes.

The first panoramic image (200) was captured by the first array (100) and the second panoramic image (205) was captured by the second array. The contribution of each imager within the frame is shown by dividing the image into segments using dashed lines (210). The first panoramic image (200) has 10 divisions, indicating that the image is a composite of the output of 10 individual imagers. For example, a first imager took a first segment (215) of the frame and a second imager took a second segment (220) of the frame. These two segments (215, 220) have been stitched together.

Similarly, the second panoramic image (205) also has 10 divisions that represent the 10 images from the companion imagers in the second array. For example, a first imager in a binocular pair took segment (220) in FIG. 2A and its companion imager took corresponding segment (221) in FIG. 2B. As discussed above, the imager pairs have a parallax offset that results in slightly different viewing angles.

FIGS. 2C and 2D are illustrative left and right binocular views (230, 232) created by an imager pair or pairs that provide stereoscopic perspective. The differences in perspective are slight and hardly noticeable in the separate views. However, when the views are superimposed, the differences become more apparent. FIG. 2E, the left and right views (230, 232) have been overlaid. Foreground objects (236) show more parallax shift than midground objects (238). The parallax shift in the background objects (240) is hardly visible in this image. When the left and right views are selectively viewed by the left eye and right eye, parallax shifts are interpreted as differences in depth. Objects with larger parallax shifts are interpreted as closer to the observer and objects with less parallax shift are interpreted as farther away. When combined with other visual cues present in images (such as size differences, occlusion, contrast differences, shadows, etc.) the parallax shifts allow the observer to intuitively and rapidly understand the content of the image.

FIG. 3 is a diagram of an illustrative panoramic stereoscopic camera (310) mounted to an armored vehicle (300). As discussed above, it may be advantageous for military personnel to remain within the armored vehicle (300) in some environments. The panoramic stereoscopic camera (310) provides 360 degree imagery to the occupants. The camera (310) has several advantages over periscopes and portholes. First, in contrast to the limited views of periscopes and portholes, the camera (310) provides 360 degree imagery. Second, the camera (310) generates electronic data that can be used simultaneously by multiple occupants of the vehicle. For example, the driver, the commander and the gunner can all use the 360 degree imagery simultaneously. Third, the data produced by the camera can be merged with other data. For example, the driver's view may be merged with GPS waypoints, street maps, topographic features, and other information. The commander's view may include mission objectives and locations of friendly positions. The gunner's view may include gun sites, target identification, range to target information, and weapon readiness.

FIG. 4 is a diagram of an illustrative panoramic stereoscopic camera mounted to an unmanned helicopter. In this example, the panoramic stereoscopic camera may be configured to view a hemisphere rather than a 360 degree plane. This can be accomplished by adding additional imagers to expand the field of view. This hemispherical view allows the remote operators of the helicopter to view the area below the helicopter as well as the 360 degree surroundings.

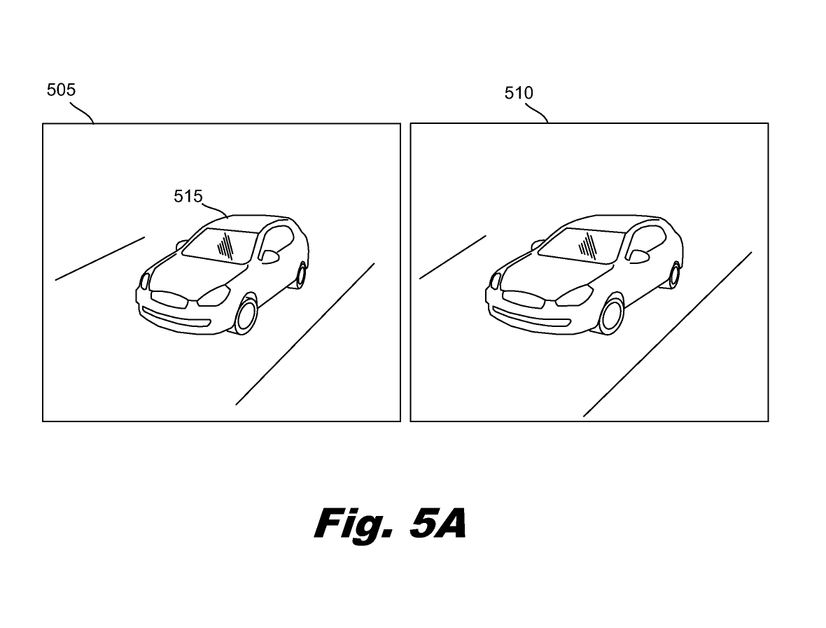

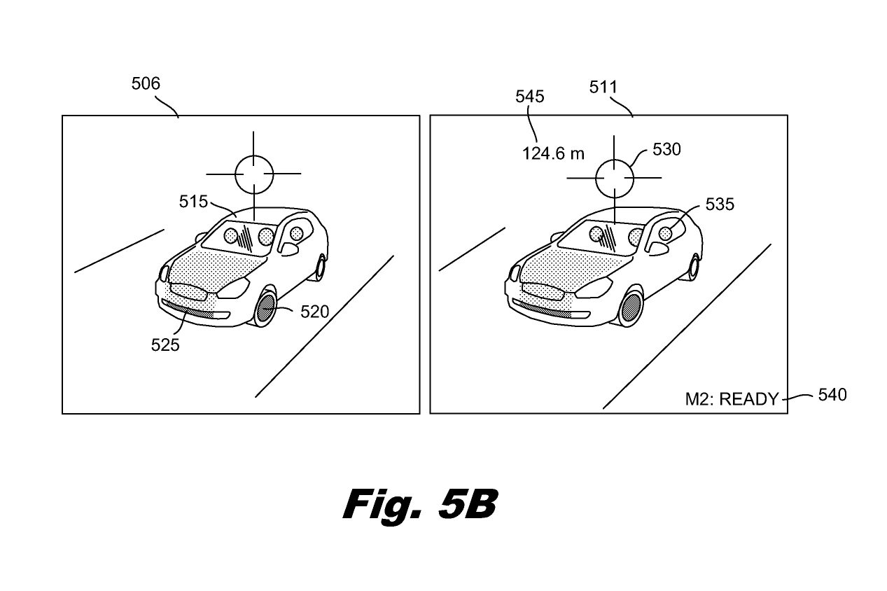

FIG. 5A is a diagram of two binocular views (505, 510) taken by a panoramic stereoscopic camera. The views (505, 510) are small portions of the panoramic data generated by the camera. In this example, a gunner in an armored vehicle has zoomed into this particular view to determine if this approaching vehicle (515) poses a threat. The two binocular views have been taken at different parallax perspectives. Consequently, the perspective angles of the vehicle are different between the first view (505) and the second view (510). According to one illustrative example, the first view (505) is presented to the gunner's left eye and the second view (510) is presented to the gunner's right eye. The gunner then has a stereoscopic view of the vehicle and can more intuitively identify the distance, speed, and direction of the vehicle. Additionally, the stereoscopic view may allow the gunner to more accurately identify characteristics of the vehicle which indicate that it may be a threat. For example, the gunner may evaluate the vehicle for characteristics that indicate it carries a car bomb or may contain armed occupants. These characteristics may include excessive speed, the number and type of occupants, unusually high cargo weight, and other characteristics. The gunner has a very limited amount of time to make this determination and to take a corresponding action. The panoramic nature of the imagery provides context for the decision and the stereoscopic nature of the imagery can significantly aid the gunner in making a correct decision and implementing it.

FIG. 5B is a diagram of two composite binocular views (506, 511) taken by a panoramic stereoscopic camera that combine multiple types of data. In this example, infrared and visible data have been combined to show the temperatures of objects in the scene superimposed on the visible image. Higher temperatures are indicated by shaded regions. A central portion (520) of the vehicle's front tire is shaded. This indicates that recent braking activity has heated the front brakes, disk, and wheel. The shaded area (525) in the front of the car may indicate that the vehicle has been driven for a long enough time for the radiator and engine to reach operational temperature.

A variety of other data can also be combined with the panoramic stereoscopic data. For example, the data can be merged with remotely operated weapon stations. In the views (505, 510) of FIG. 5B, a weapons sight (530) is shown. Additionally, in the right view (510), the range to target (545) and weapon status (540) are shown. A variety of other information could also be displayed.

In addition to the combination of other sensors in the panoramic stereoscopic camera, image analysis could be used to extract and emphasize features in the images. In this example, image analysis has been used to identify individuals in the vehicle. These individuals are represented as shaded ovals (535) in the interior of the vehicle. This image enhancement may be facilitated by the stereoscopic views produced by the camera. The stereoscopic views may allow for reduction of noise, obstructions, and other artifacts in the data. For simplicity, the process for delivering a single panoramic stereoscopic image has been described. A series of these images is delivered to provide real time motion imagery to the user. For example, the images may be delivered at rates of 30 frames per second or higher.

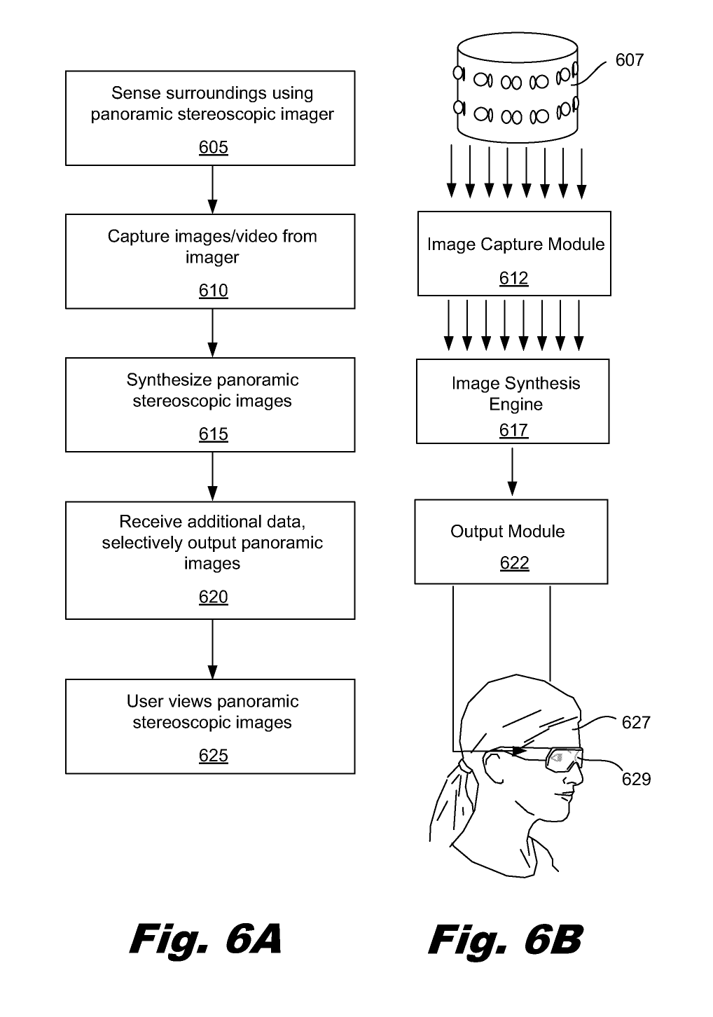

FIGS. 6A and 6B are diagrams of an illustrative method and system, respectively, for creating and using panoramic stereoscopic images. In a first block (605), the surroundings are sensed using a panoramic stereoscopic camera (607). As discussed above, the camera (607) may have a variety of viewing angles and imager configurations. In second block (610), images generated by the camera (607) are captured and converted into digital data. The original images may be still images or video streams. In a third block (615), the images are synthesized into panoramic stereoscopic images. This synthesis is performed by an image synthesis engine (617). The image synthesis engine (617) may perform a variety of tasks including, but not limited to, image stitching, adjusting for lens aberrations, image stabilization, removal of visual artifacts, color balancing, feature extraction, and other tasks. In a fourth block (620), an output module (622) receives additionally data from other sensors and combines it with the panoramic images. The output module (622) receives information describing portions of the images the operator desires to view. This information may be supplied by manual input from the user, from head position sensors, or from other devices. The user (627) then views the panoramic stereoscopic images (625). For example, the panoramic stereoscopic images may be viewed using glasses (629) that individually project images into the user's left and right eyes. As discussed above, more than one user can simultaneously use the imagery. For example, in a combat situation, a vehicle commander, gunner, driver, and remote command post may simultaneously view all or selected portions of the imagery.

The system and method described above are only illustrative examples. A variety of different configurations could be used and blocks could be added, omitted or combined. For example, the system could include concentrators that combine video input from multiple imagers prior to frame grabbing. Additionally, the system may include modules that compress, archive, and/or transmit the images. In some examples, only the more relevant portions of the images would be archived or transmitted.

The specification and figures herein describe systems and methods for creating and using panoramic stereoscopic images. The combination of a panoramic field of view with stereoscopic perspective provides superior imagery that is more intuitively interpreted by a user. The panoramic stereoscopic images may provide advantages in filming for entertainment, security, surveillance, peacekeeping, and other applications.

The preceding description has been presented only to illustrate and describe examples of the principles described. This description is not intended to be exhaustive or to limit these principles to any precise form disclosed. Many modifications and variations are possible in light of the above disclosure.

What is claimed is:

1. A panoramic stereographic camera comprising:
a first cylindrical array of imagers with adjoining fields of view that cover a panoramic portion of a scene, each imager in the first cylindrical array being oriented at a first skew angle with respect to a radial line passing from a center of the first cylindrical array through a reference point in each imager; and
a second cylindrical array of imagers with adjoining fields of view that cover the same panoramic portion of the scene, each imager in the second cylindrical array being oriented at a second skew angle with respect to a radial line passing from a center of the second cylindrical array through a reference point in each imager and having a parallax offset from the first cylindrical array of imagers;
in which imagers in a cylindrical array that share a field of view have at least one imager interposed between them, and images formed by the first cylindrical array of imagers and images created by the second cylindrical array of imagers are combined to produce a panoramic stereographic image.

2. The camera of claim 1, in which each of the imagers in the first cylindrical array is paired with an imager in the second cylindrical array to form binocular pairs, the binocular pairs providing a stereoscopic view of part of the panoramic portion.

3. The camera of claim 2, in which the optical center line of each imager in a binocular pair is parallel to and offset from a radial line that passes from the center of the array outward to a point midway between the two imagers in the binocular pair.

4. The camera of claim 2, in which a parallax between binocular pairs is uniform in all binocular pairs in the camera.

5. The camera of claim 2, in which the binocular pairs are interspersed with each other such that the parallax offset is greater than the radius of a circle passing through all in the imagers in the first and second arrays.

6. The camera of claim 1, further comprising a third cylindrical array and a fourth cylindrical array of imagers, in which the imagers in the third and fourth array operate at different optical wavelengths than the imagers in the first and second cylindrical arrays.

7. The camera of claim 1, further comprising additional imager pairs that are placed to provide a hemispherical panoramic stereoscopic view.

8. The camera of claim 1, in which the camera produces a continuous 360 degree stereoscopic panorama.

9. The camera of claim 1, in which differences between pointing angles of successive imagers in the first array are equal to or less than an individual field of view of the imagers in the first and second cylindrical arrays.

10. The camera of claim 1, in which the parallax offset between imagers in a pair is between 45 and 75 millimeters.

11. The camera of claim 1, in which the imagers in the first cylindrical array point in a clockwise orientation at the first skew angle and the imagers in the second cylindrical array point in a counterclockwise orientation at the second skew angle.

12. The camera of claim 1, in which the second skew angle has the same magnitude but opposite sign of the first skew angle.

13. The camera of claim 1, in which fields of view of imagers in the first cylindrical array directly abut each other to provide 360 degree coverage without gaps or substantial overlap, and the fields of view of imagers in the second cylindrical array directly abut each other to provide 360 degree coverage without gaps or substantial overlap.

14. A system comprising:
a panoramic stereoscopic imager comprising a plurality of coplanar binocular pairs of imagers arranged in a 360 degree cylindrical array, the coplanar binocular pairs of imagers being interspersed among each other such that each binocular pair of imagers is separated by at least one imager;
an image capture module for capturing images from the imagers;
an image synthesis engine for combining the captured images into a panoramic stereoscopic image; and
an output module for selectively outputting portions of the panoramic stereoscopic image to a user.

15. The system of claim 14, further comprising a second plurality of binocular pairs of imagers operating at a different optical wavelength, in which data generated by the second plurality of binocular pairs of imagers is merged with the panoramic stereoscopic image.

16. The system of claim 14, in which the imagers are arranged in a first cylindrical array and a second cylindrical array; the first cylindrical array and second cylindrical array being mutually coplanar and coaxial; imagers in the first cylindrical array pointing in a clockwise orientation at a first skew angle and imagers in the second cylindrical array point in a counterclockwise orientation at the second skew angle; each imager in the first cylindrical array being paired with an imager in the second cylindrical array to form the binocular pairs.

17. The system of claim 16, in which fields of view of imagers in the first cylindrical array directly abut each other to provide 360 degree coverage without substantial gaps or overlap, and the fields of view of imagers in the second cylindrical array directly abut each other to provide 360 degree coverage without substantial gaps or overlap.

18. The system of claim 14, in which each of the plurality of binocular pairs of imagers is coplanar.

19. The system of claim 14, in which each of the plurality of coplanar binocular pairs of imagers exhibit the same horizontal parallax.
